(19) United States
(12) Patent Application Publication
(10) Pub. No.: US 2021/0142354 A1
(43) Pub. Date: May 13, 2021

(54) SYSTEMS AND METHODS TO ENABLE TIME-BASED REWARDS FOR STREAMING MEDIA CONSUMPTION

(71) Applicant: Qixu Cao, Falls Church, VA (US)

(72) Inventor: Qixu Cao, Falls Church, VA (US)

(21) Appl. No.: 16/903,141

(22) Filed: Jun. 16, 2020

Related U.S. Application Data
(60) Provisional application No. 62/932,659, filed on Nov. 8, 2019.

(51) Int. Cl. G06Q 30/02; H04N 21/442; H04N 21/441

(52) U.S. Cl. CPC G06Q 30/0231; H04N 21/441; H04N 21/44204; H04N 21/44218

(57) ABSTRACT

A system to enable time-based rewards for streaming media consumption includes a user device that includes a user interface and a streaming media player. A streaming media server communicatively is coupled to the user device and comprises a streaming media file. A control circuit is communicatively coupled to the user device and the streaming media server. The streaming media player is configured to stream media files. The control circuit is configured to: generate a start time when the user device initiates streaming of the streaming media file; generate an end timer when the user device terminates streaming of the streaming media content file; determine a time period, the time period is the difference between the end time and the start time; convert the time period to a plurality of time intervals; convert each of the time intervals to a reward point; and convey, via the user interface, the reward point.

### CROSS-REFERENCE TO RELATED APPLICATIONS

This application claims priority to U.S. Provisional Application No. 62/932,659 filed Nov. 8, 2019, which is hereby incorporated herein by reference.

### FIELD OF THE INVENTION

The present disclosure relates generally to streaming media. More specifically, the present disclosure describes systems and methods to enable time-based rewards for streaming media consumption.

### BACKGROUND OF THE INVENTION

Streaming media is multimedia that is constantly received by and presented to an end-user while being delivered by a provider. The verb “to stream” refers to the process of delivering or obtaining media in this manner; the term refers to the delivery method of the medium, rather than the medium itself, and is an alternative to file downloading, a process in which the end-user obtains the entire file for the content before watching or listening to it. A media stream can be streamed either “live” or “on demand”. Live streams are generally provided by a means called “true streaming”. True streaming sends the information straight to the computer or device without saving the file to a hard disk. On-demand streaming is provided by a means called progressive streaming or progressive download.

A client end-user can use their media player to start playing digital video or digital audio content before the entire file has been transmitted. Advances in computer networking, combined with powerful home computers and modern operating systems, have made streaming media practical and affordable for ordinary citizens. For example, stand-alone Internet radio devices emerged to offer listeners a no-computer option for listening to audio streams. Streaming media devices are consumer electronics devices designed for the storage, playback, or viewing of digital media content. They are typically designed to be integrated into a home cinema configuration and attached to a television, computer monitor, and/or A/V receiver.

### BRIEF DESCRIPTION OF THE DRAWINGS

Some of the embodiments will be described in detail, with reference to the following figures, wherein like designations denote like members, wherein:

FIG. 1 is a block diagram that illustrates an environment to enable time-based rewards for streaming media consumption according to some embodiments.

FIG. 2 illustrates a relationship between data packets, time periods, and time intervals according to other embodiments.

FIG. 3 is block diagram that illustrates a decentralized, distributed network of digital ledgers according to certain embodiments.

FIG. 4 is a flowchart that depicts process steps of a method to enable time-based rewards for streaming media consumption according to yet still others embodiments.

FIG. 5 is a flowchart that depicts process steps of a method to enable time-based rewards for streaming media consumption according to some embodiments.

FIG. 6 is a flowchart that depicts process steps of a method to enable time-based rewards for streaming media consumption according to other embodiments.

FIG. 7 is a flowchart that depicts process steps of a method to enable time-based rewards for streaming media consumption according to certain embodiments.

FIG. 8 is a flowchart that depicts process steps of a method to enable time-based rewards for streaming media consumption according yet still other embodiments.

FIG. 9 is a flowchart that depicts process steps of a method to enable time-based rewards for streaming media consumption according to some embodiments.

FIG. 10 depicts a block diagram illustrating an example operating environment for a computing device configured in accordance with various embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

The present disclosure includes many aspects and features. Moreover, while many aspects and features relate to, and are described in the context of detection of presence of one or more intruder devices., embodiments of the present disclosure are not limited to use only in this context.

Streaming media is multimedia that is constantly received by and presented to an end-user while being delivered by a provider. The verb “to stream” refers to the process of delivering or obtaining media in this manner; the term refers to the delivery method of the medium, rather than the medium itself, and is an alternative to file downloading, a process in which the end-user obtains the entire file for the content before watching or listening to it. A media stream can be streamed either “live” or “on demand”. Live streams are generally provided by a means called “true streaming”. True streaming sends the information straight to the computer or device without saving the file to a hard disk. On-demand streaming is provided by a means called progressive streaming or progressive download.

A client end-user can use their media player to start playing digital video or digital audio content before the entire file has been transmitted. Advances in computer networking, combined with powerful home computers and modern operating systems, have made streaming media practical and affordable for ordinary citizens. For example, stand-alone Internet radio devices emerged to offer listeners a no-computer option for listening to audio streams. Streaming media devices are consumer electronics devices designed for the storage, playback, or viewing of digital media content. They are typically designed to be integrated into a home cinema configuration and attached to a television, computer monitor, and/or A/V receiver.

Conventional streaming media sources may do not allow users to earn reward points for viewing and listening to streaming media. Therefore, there is a need for improved systems and methods to enable time-based rewards for streaming media consumption that may address one or more of the above-mentioned limitations.

Referring now to the FIGS. FIG. 1 is a block diagram that illustrates an environment, generally 100, to enable time-based rewards for streaming media consumption according to some embodiments. Environment 100 preferably includes one or more computing device 155, user computing device 130 and computing device 105 interconnected via network 125. The network 125 can be, for example, a local area network (LAN), wide area network (WAN) such as the Internet, or a combination of the two, and can include wired, wireless, or fiber optic connections. In certain embodiments, the network 125 can be a decentralized, distributed network (e.g., a blockchain). The term “blockchain” refers to growing list of records, called “blocks,” that are linked using cryptography. Each block contains a cryptographic hash of the previous block, a timestamp, and transaction data (generally represented as a Merkle tree). In such embodiments, the network 125 includes a plurality of nodes 170 (discussed further below). In general, the network 125 can be any combination of connections and protocols that support communications between the computing device 155, node 170, user computing device 130, and computing device 105.

The computing device 155, node 170, user computing device 130, and computing device 105 can, for example, each be a desktop computer, a wearable computer, a mobile computing device, a laptop computer, a tablet computer, a computer server, a vehicular-based computer, a home-integrated computer, a thin client, and/or any computing device that can cute code and communicate, in accordance with an embodiment of the present invention. The computing device 155 is preferably a streaming media server that includes a data store 160, which is a repository for storing streaming media files 165. The streaming media files 165 preferably include one or more streaming audio files and/or streaming video files.

Streaming media, such as streaming audio and/or streaming video, is multimedia that is constantly received by and presented to an end-user while being delivered by a provider. As used herein, “streaming” refers to the process of delivering or obtaining media in this manner. In certain embodiments, the streaming media files 165 include live streamed media (i.e. media delivered in real-time). The computing device 155 is preferably a streaming media server that transmits, via the network 125, streaming media files 165 to the user computing device 130 for presentation via a streaming media player 145. The user computing device 130 is a device that streams media according to preferred embodiments. The user computing device 130 includes user interface 135, media player 145, and biometric sensor 150. The user interface 135 preferably displays information (e.g., reward points) transmitted by the computing device 105. According to some embodiments, the user interface 135 displays a graphical icon 140 that is interactive with the user 180 (discussed further below).

The streaming media player 145 is software configured to stream media (e.g., audio and video) files (e.g., the streaming media files 165). The biometric sensor 150 is a security and authentication device. The biometric sensor 150 can capture biometric data associated with the user of the user computing device 130. For example, the biometric sensor 150 can capture visual biometric data (e.g., fingerprints, iris scans, facial scans, retinal scans) and/or auditory biometric data (e.g., voice signatures). The biometric sensor 150 can be different types of sensors that each capture a type of biometric data.

The computing device 105 includes control circuit 110 communicatively coupled to data store 115. In some embodiments, the computing device 105 is a plurality of computers on a network that are configured to perform as a single entity (i.e. a cluster computer). In other embodiments, the computing device 105 and the user computing device 130 are a single unit as opposed to separate units as depicted in FIG. 1. The computing device 105 is a device that can enable time-based rewards for streaming media consumption. The control circuit 110 is one or more integrated circuits configured to perform one or more steps, process, and/or methods disclosed herein. The data store 115 is a digital repository for storing and managing data (e.g., files 120). According to preferred embodiments, the files 120 include reward point, historic reward points, authentication data (e.g., received from the user computing device 130). In other embodiments, the files 120 also include distributed ledger 175 (discussed above).

FIG. 2 illustrates a relationship between data packets, time periods, and time intervals, generally 200, 220, and 225, respectively, according to other embodiments. Briefly, media files converted to a plurality of data packets 200 (e.g., n+1 data packets) that are individually transmitted to the end user. For example, data packet 1 can be played at the same time as data packet 2 is downloading. In this manner, the user can begin viewing the media file before it is completely downloaded. Time period 220 preferably initiates with start time 205 and concludes with end time 210. The time period 220 is converted to a plurality of time intervals 225 (e.g., t+3 time intervals) of equal duration that are each converted to one or more rewards points using a predefined criteria (e.g., 5 reward point per time interval 225). To be sure, predefined criteria can be media type dependent (e.g., video and audio) or uniform across media types.

According to preferred embodiments, users receive reward points on a one user per stream basis. In other words, the user 180 may not login multiple times to access multiple media files 165 and thereby gain reward points for each viewing (i.e. the user 180 is incapable of multiple logins). The streaming of streaming media files 165 is terminated when the user 180 attempts simultaneous logins and/or simultaneous streams of multiple copies of the streaming media files 165. The restriction on multiple logins and simultaneous streaming seeks to reduce the ability of the user 180 to manipulate the disclosed rewards process for a desired outcome.

FIG. 3 is block diagram that illustrates a decentralized, distributed network, for example network 125, of digital ledgers according to certain embodiments. In certain embodiments, the computing device 105 and a plurality of nodes 170 form a decentralized, distributed network (e.g., a blockchain network). Here, the computing device 105 and a plurality of nodes 170 each include a copy of distributed ledger 175, which include authentication data (e.g., information that is unique to the user, such as biometric data and/or passwords). For example, the distributed ledger 175 can be a growing list of records, e.g., authentication data, that are linked using cryptography wherein each block contains a cryptographic hash of the previous record, a timestamp, and transaction data. The distributed ledger 175 is resistant to modification of the data.

For example, once recorded, the data in any given record cannot be altered retroactively without alteration of all subsequent records, which requires consensus of the majority of the network (e.g., the plurality of nodes 170). In this manner, data is verified using a decentralized consensus. Data quality of the distributed ledger 175 is maintained by distributed ledger 175 replication and computational trust. No centralized “official” copy exists and no individual network node (e.g., node 170) is “trusted” more than any other. Entries of the distributed ledger 175 are broadcast to the network 125 using software and delivered on a best-effort basis. The plurality of nodes 170 verify ledger entries using one or more consensus methods to achieve distributed consensus.

FIG. 4 is a flowchart that depicts process steps of a method to enable time-based rewards for streaming media consumption according to yet still others embodiments. At Step 400, a start time 205 is generated when the user device (e.g., the user computing device 130) initiates streaming of one of the streaming media files 165. At Step 405, an end time 210 is generated when the user device terminates streaming of the streaming media content file. At step 410, a time period 220 is determined that is the difference between the end time 210 and the start time 205. At Step 415, the time period 220 is converted to a plurality of time intervals 225. At Step 420, each of the time intervals 225 are converted to at least one reward point. At Step 425, the reward point is conveyed via the user interface 135.

FIG. 5 is a flowchart that depicts process steps of a method to enable time-based rewards for streaming media consumption according to some embodiments. Specifically, FIG. 5 depicts process steps to enable generating the start time 205 (i.e. Step 400) according to some embodiments. At Step 500, a graphical icon 140 is conveyed via the user interface 135 subsequent to generating the start time 205, wherein the graphical icon 140 is configured to receive interaction from user 180 of the user computing device 130. As used herein, “interaction” refers to clicking and/or selecting the graphical icon 140 using an input device (e.g., mouse, keyboard, microphone, stylus, etc.). At Step 505, the streaming media files 165 is paused when the graphical icon 140 does not receive the interaction for a predetermined time period (e.g., 30 seconds). For example, the streaming is halted when the graphical icon 140 is not selected, which means that the presence of the user is not detected.

FIG. 6 is a flowchart that depicts process steps of a method to enable time-based rewards for streaming media consumption according to other embodiments. Specifically, FIG. 6 depicts additional process steps to enable Step 400 according to other embodiments. At Step 600, an authentication request is conveyed via the user interface 135. For example, authentication requests can ask for authentication data (i.e. information that is unique to the user, such as biometric data and/or passwords). At Step 605, authentication data is received via the user computing device 130 in response to the authentication request. For example, authentication data may be entered using the user interface 135 and/or the biometric sensor 150. At Step 610, whether the authentication data shares a threshold relationship with known authentication data (e.g., stored in the files 120 and/or the distributed ledger 175) is determines. At Step 615, the start time 205 is generated when the authentication data shares the threshold relationship with the known authentication data.

FIG. 7 is a flowchart that depicts process steps of a method to enable time-based rewards for streaming media consumption according to certain embodiments. Here, to accomplish Step 605, one or more biometric data points are received from the user computing device 130 that includes a biometric sensor 150 configured to capture biometric data (Step 700). Even more, receiving the authentication data includes receiving a media access control (“MAC”) address associated with the user computing device 130 (Step 705). MAC address is a unique identifier assigned to a network interface controller (e.g., included in the user computing device 130) for use as a network address in communications within a network segment (such as a segment of the network 125). This use is common in most IEEE 802 networking technologies, including Ethernet, Wi-Fi, and Bluetooth.

FIG. 8 is a flowchart that depicts process steps of a method to enable time-based rewards for streaming media consumption according yet still other embodiments. The step of determining whether the authentication data shares the threshold relationship with the known authentication data (Step 610) can be accomplished using a variety of solutions. However, the authentication data is preferably transmitted to a plurality of distributed ledgers 175 that are communicatively coupled to each other in a decentralized and distributed manner (Step 800). The plurality of distributed ledgers 175 verify entries of an individual distributed ledgers 175 using a consensus algorithm (e.g., proof-of-stake). Each distributed ledger 175 includes the known authentication data and is configured to determine whether the authentication data shares the threshold relationship with the known authentication data (i.e. validate entries included in the distributed ledger 175).

The authentication data is determined to share the threshold relationship with the known authentication data when a threshold quantity of the plurality of distributed ledgers 175 determines the authentication data shares the threshold relationship with the known authentication data (Step 805). In other words, the plurality of the distributed ledgers 175 use a consensus algorithm (e.g., proof-of-stake) to achieve a distributed consensus that the authentication data shares the threshold relationship with the known authentication data. Even more, altering information included a copy of the distributed ledger 175 also requires altering the other distributed ledgers 175, which requires consensus of the majority of the plurality of nodes 170.

FIG. 9 is a flowchart that depicts process steps of Step 425 according to some embodiments. Historic reward points associated with the user 180 are determined (Step 900). The reward point and the historic reward points are combined to generate a reward point summary (Step 905). The reward point summary is conveyed using the user interface 135 (Step 910).

With reference to FIG. 10, a system consistent with an embodiment of the disclosure may include a computing device or cloud service, such as computing device 1000. Computing device 1000 can represent computing devices 155 and 105, nodes 170, and user computing device 130. In a basic configuration, computing device 400 may include at least one processing unit 1002 (e.g, control circuit 110) and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000′s operation. In one embodiment, programming modules 1006 may include machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet, as well as in a decentralized distributed environment, for example, a blockchain. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002 (e.g, control circuit 110), programming modules 1006 (e.g., application 1020 such as user interface 135 and streaming media player 145) may perform processes including, for example, one or more stages of methods, algorithms, systems, applications, servers, databases as described above. The aforementioned process is an example, and processing unit 1002 (e.g, control circuit 110) may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

What is claimed is:

1. A system to enable time-based rewards for streaming media consumption, comprising:
a user device comprising a user interface and a streaming media player;
a streaming media server communicatively coupled to the user device and comprising a streaming media file;
a control circuit communicatively coupled to the user device and the streaming media server;
wherein the streaming media player is configured to stream media files;
wherein the control circuit is configured to:
generate a start time when the user device initiates streaming of the streaming media file;
generate an end timer when the user device terminates streaming of the streaming media content file;
determine a time period, the time period is the difference between the end time and the start time;
convert the time period to a plurality of time intervals;
convert each of the time intervals to a reward point; and
convey, via the user interface, the reward point.

2. The system of claim 1, wherein in generating the start time the control circuit is configured to:
convey, via the user interface, a graphical icon subsequent to generating the start time, the graphical icon configured to receive interaction from a user of the user device; and
pause streaming of the streaming media file when the graphical icon does not receive the interaction for a predetermined time period.

3. The system of claim 2, wherein in generating the start time the control circuit is configured to:
convey, via the user interface, an authentication request;
receive, via the user device, authentication data in response to the authentication request;
determine whether the authentication data shares a threshold relationship with known authentication data; and
generate the start time when the authentication data shares the threshold relationship with the known authentication data.

4. The system of claim 3, wherein
the user device comprises a biometric sensor configured to capture biometric data; and
receiving the authentication data comprises receiving, via the control circuit, a biometric data point from the user computing device, the biometric data point captured via the biometric sensor.

5. The method of claim 4, wherein
receiving the authentication data comprises capturing, via the control circuit, a MAC address associated with the user device.

6. The system of claim 5, further comprising:
a plurality of digital ledgers each communicatively coupled to the control circuit;
wherein
the plurality of digital ledgers are identical, decentralized and distributed;
each digital ledger comprises the known authentication date;
each digital ledger is configured to determine whether the authentication data shares the threshold relationship with the known authentication data;
in determining whether the authentication data shares the threshold relationship with the known authentication data the control circuit is further configured to:
transmit the authentication data to the plurality of digital ledgers; and
determine the authentication data shares the threshold relationship with the known authentication data when a threshold quantity of the plurality of digital ledgers determines the authentication data shares the threshold relationship with the known authentication data.

7. The system of claim 6, wherein in conveying the reward point the control circuit is configured to:
determine historic reward points associated with the user;
combine the reward point and the historic reward points to generate a reward point summary; and
convey, via the user interface, the reward point summary.

8. A method to enable time-based rewards for streaming media consumption, comprising:
generating, via a control circuit, a start time when a user device initiates streaming of a streaming media file, the user device comprising an user interface and a streaming player, the streaming media file stored in a streaming media server, the streaming media server communicatively coupled to the user device and configured to stream ;
generating, via the control circuit, an end timer when the user device terminates streaming of the streaming media content file;
determining, via the control circuit, a time period, the time period is the difference between the end time and the start time;
converting, via the control circuit, the time period to a plurality of time intervals;
converting, via the control circuit, each of the time intervals to a reward point; and
conveying, via the control circuit, via the user interface, the reward point

9. The method of claim 8, wherein generating the start time comprises:
conveying, via the control circuit, a graphical icon via the user interface subsequent to generating the start time, the graphical icon configured to receive interaction from a user of the user device; and
pausing, via the control circuit, the streaming of the streaming media file when the graphical icon does not receive the interaction for a predetermined time period.

10. The method of claim 9, wherein generating the start time comprises:
conveying, via the control circuit, an authentication request via the user interface;
receiving, via the control circuit, authentication data via the user device in response to the authentication request;
determining, via the control circuit, whether the authentication data shares a threshold relationship with known authentication data; and
generating, via the control circuit, the start time when the authentication data shares the threshold relationship with the known authentication data.

11. The method of claim 10, wherein
the user device comprises a biometric sensor configured to capture biometric data; and
receiving the authentication data comprises receiving, via the control circuit, a biometric data point from the user device, the biometric data point captured via the biometric sensor.

12. The method of claim 11, wherein
receiving the authentication data comprises capturing, via the control circuit, a media access control (“MAC’) address associated with the user device.

13. The method of claim 12, wherein
determining whether the authentication data shares the threshold relationship with the known authentication data comprises:
transmitting, via the control circuit, the authentication data to a plurality of digital ledgers, the plurality of digital ledgers are communicatively coupled to each other in a decentralized and distributed manner;
determining, via the control circuit, that the authentication data shares the threshold relationship with the known authentication data when a threshold quantity of the plurality of digital ledgers determines the authentication data shares the threshold relationship with the known authentication data;
wherein
each digital ledger comprises the known authentication data; and
each digital ledger is configured to determine whether the authentication data shares the threshold relationship with the known authentication data.

14. The method of claim 13, wherein conveying the reward point comprises:
determining, via the control circuit, historic reward points associated with the user;
combining, via the control circuit, the reward point and the historic reward points to generate a reward point summary; and
conveying, via the control circuit, the reward point summary via the user interface.

15. A method to enable time-based rewards for streaming media consumption, comprising:
generating, via a control circuit, a start time when a user device initiates streaming of a streaming media file, the user device comprising an user interface and a streaming player, the streaming media file stored in a streaming media server, the streaming media server communicatively coupled to the user device and configured to stream ;
conveying, via the control circuit, a graphical icon via the user interface subsequent to generating the start time, the graphical icon configured to receive interaction from a user of the user device;
pausing, via the control circuit, the streaming of the streaming media file when the graphical icon does not receive the interaction for a predetermined time period;
generating, via the control circuit, an end timer when the user device terminates streaming of the streaming media content file;
determining, via the control circuit, a time period, the time period is the difference between the end time and the start time;
converting, via the control circuit, the time period to a plurality of time intervals;
converting, via the control circuit, each of the time intervals to a reward point; and
conveying, via the control circuit, via the user interface, the reward point

16. The method of claim 15, wherein generating the start time comprises:
conveying, via the control circuit, a graphical icon via the user interface subsequent to generating the start time, the graphical icon configured to receive interaction from a user of the user device; and
pausing, via the control circuit, the streaming of the streaming media file when the graphical icon does not receive the interaction for a predetermined time period.

17. The method of claim 16, wherein generating the start time comprises:
conveying, via the control circuit, an authentication request via the user interface;
receiving, via the control circuit, authentication data from the user device in response to the authentication request;
determining, via the control circuit, whether the authentication data shares a threshold relationship with known authentication data; and
generating, via the control circuit, the start time when the authentication data shares the threshold relationship with the known authentication data.

18. The method of claim 17, wherein
the user device comprises a biometric sensor configured to capture biometric data;
receiving the authentication data comprises receiving, via the control circuit, a biometric data point from the user device, the biometric data point captured via the biometric sensor; and
receiving the authentication data comprises capturing, via the control circuit, a MAC address associated with the user computing device.

19. The method of claim 18, wherein
determining whether the authentication data shares the threshold relationship with the known authentication data comprises:
transmitting, via the control circuit, the authentication data to a plurality of digital ledgers, the plurality of digital ledgers are communicatively coupled to each other, identical, decentralized and distributed;
determining, via the control circuit, that the authentication data shares the threshold relationship with the known authentication data when a threshold quantity of the plurality of digital ledgers determines the authentication data shares the threshold relationship with the known authentication data;
each digital ledger comprises the known authentication date; and
each digital ledger is configured to determine whether the authentication data.

20. The method of claim 19, wherein conveying the reward point the control comprising:
determining, via the control circuit, historic reward points associated with the user;
combining, via the control circuit, the reward point and the historic reward points to generate a reward point summary; and
conveying, via the control circuit, the reward point summary via the user interface.
